(19) United States
(12) Patent Application Publication
(10) Pub. No.: US 2013/0264727 A1
(43) Pub. Date: Oct. 10, 2013

(54) FILM TRANSFER METHOD AND APPEARANCE MEMBER MANUFACTURED BY USING THE SAME

(71) Applicant: COMPAL ELECTRONICS, INC., Taipei City (TW)

(72) Inventors: Jih-Houng LEE, Taipei City (TW); Ming-Chung PENG, Taipei City (TW)

(73) Assignee: COMPAL ELECTRONICS, INC., Taipei City (TW)

(21) Appl. No.: 13/798,146

(22) Filed: Mar. 13, 2013

Related U.S. Application Data
(60) Provisional application No. 61/620,966, filed on Apr. 5, 2012.

(51) Int. Cl. B29D 11/00; B29C 45/40; B29C 45/02

(52) U.S. Cl. CPC B29D 11/00769; B29C 45/02; B29C 45/40
USPC 264/1.1; 264/328.1; 264/300

(57) ABSTRACT

A film transfer method is provided and includes the following steps: A mold apparatus is provided. In a mold cavity of the mold apparatus, a film substrate having a three-dimensional texture layer is provided. A melted plastic is injected into the mold cavity, such that the melted plastic covers the three-dimensional texture layer of the film substrate. The melted plastic is solidified. The solidified plastic is separated from the three-dimensional texture layer of the film substrate.

### RELATED APPLICATIONS

This application claims priority to U.S. Provisional Application Ser. No. 61/620,966, filed Apr. 5, 2012, which is herein incorporated by reference.

### BACKGROUND

1. Field of Invention

The invention relates to a film transfer method and an appearance member manufactured by using the film transfer method.

2. Description of Related Art

With the never-ending changes and improvement of the consumer electronics, the competition among electronics of different brands is very fierce. The consumer has a higher and higher requirement to the notebook computer, tablet computer, smart phone, photographic camera and camera. In addition to the hardware specification of the electronics (such as the processor, screen size and pixel, and camera pixel), the consumer also pays much attention to the appearance design of the electronics.

Taking a current plastic shell as an example, if the surface of the shell has a texture with a concave-convex structure, the tactile sensation when the skin contacts this surface is different from the tactile sensation of touching a smooth plane. Furthermore, the texture with the concave-convex structure can enable the light to be diffracted, and thus when the surface of the shell is viewed, an effect with many variations in visual can be obtained. When a plastic shell with a concave-convex structure is manufactured, typically concave or convex, continuous or in-continuous processes are applied to a mold apparatus (a male mold or female mold), to form patterns (such as textures) on partial or entire surface of the mold apparatus. Subsequently, the plastic injection process is performed, when the liquid plastic contacts the patterns of the mold apparatus, a decorative texture corresponding to the surface patterns of the mold apparatus can be formed on the solidified plastic. However, forming a plastic shell having a decorative texture needs a mold apparatus with such a decorative texture, which increases the cost of the mold apparatus.

Here are several methods for forming concave and convex patterns on the mold apparatus surface. Concave and convex patterns are etched on the mold apparatus by using strong acid or base liquid and a light sensitive film. Alternatively, concave and convex patterns are engraved on the mold apparatus with different processing knife tools. Concave and convex patterns are engraved on the mold apparatus with a laser processing knife tool. Alternatively, a decorative film with a texture is implanted on the mold apparatus, so that the surface of the plastic shell is formed by combining the decorative film with a plastic material. Alternatively, methods such as laser, tooling, etching, printing, painting and adhering of decorative objects are directly performed on the surface of a molded plastic shell.

In view of the above, the conventional method for manufacturing a plastic shell with a concave-convex structure is power-wasting, time-wasting, labor-wasting, and mold-apparatus-wasting, and environment pollution is caused as using the strong acid or strong base, which causes bodily harm to the staff.

### SUMMARY

An aspect of the invention provides a film transfer method.

According to an embodiment of the invention, a film transfer method includes the following steps. A mold apparatus is provided. A film substrate having a three-dimensional texture layer is provided in a mold cavity of the mold apparatus. A melted plastic is injected into the mold cavity, such that the melted plastic covers the three-dimensional texture layer of the film substrate. The melted plastic is solidified. The solidified plastic is separated from the three-dimensional texture layer of the film substrate.

In an embodiment of the invention, the film transfer method further includes: coating a mold release layer on the three-dimensional texture layer of the film substrate; and oven-drying the mold release layer.

In an embodiment of the invention, the mold release layer is used for separating the solidified plastic from the three-dimensional texture layer of the film substrate.

In an embodiment of the invention, the film transfer method further includes: providing two rollers at two opposite sides of the mold apparatus, wherein two ends of the film substrate are respectively connected to the two rollers; and roiling the two rollers, such that the film substrate moves on the mold apparatus.

In an embodiment of the invention, the film transfer method further includes: closing the mold apparatus, such that the film substrate is positioned in the mold cavity of the mold apparatus.

In an embodiment of the invention, the film transfer method further includes: demounting the mold apparatus and acquiring the solidified plastic from the mold apparatus.

In an embodiment of the invention, the film substrate is plate-shaped.

In an embodiment of the invention, the three-dimensional texture layer includes a printing ink or ultraviolet-solidified gel.

In an embodiment of the invention, the three-dimensional texture layer includes a flatting silica, aluminium powder or pearl powder.

In an embodiment of the invention, the material of the film substrate includes polyethylene terephthalate (PET).

In an embodiment of the invention, the three-dimensional texture layer is formed through intaglio printing, screen painting, imprinting or nano imprinting lithography.

Another aspect of the invention provides an appearance member manufactured through the aforesaid film transfer method.

According to an embodiment of the invention, an appearance member includes a surface. The surface has a concave-convex structure, and the pattern of the concave-convex structure is the same as the three-dimensional texture layer of the film substrate.

In an embodiment of the invention, the concave-convex structure is an optical diffraction structure for diffracting a light which irradiates the concave-convex structure.

In an embodiment of the invention, the concave-convex structure is a touch sensing structure with different roughness.

In an embodiment of the invention, the height difference in the concave-convex structure is from 1 to 50 μm.

In the aforesaid embodiments of the invention, since the film substrate having the three-dimensional texture layer is positioned in the mold cavity of the mold apparatus, when the melted plastic is injected into the mold cavity, the melted plastic covers the three-dimensional texture layer of the film substrate. As such, when the melted plastic is solidified, it only needs to separate the solidified plastic from the three-dimensional texture layer of the film substrate, and thus the surface of the solidified plastic facing the three-dimensional texture layer has the concave-convex structure. The aforesaid solidified plastic may be an appearance member, and the pattern of the concave-convex structure is approximately the same as the three-dimensional texture layer of the film substrate.

This film transfer method uses the film substrate having the three-dimensional texture layer to form the concave-convex structure of the appearance member. When the concave-convex structure of the appearance member needs to be replaced by a different decorative texture, it only needs to replace the film substrate by a film substrate of another type, and the mold apparatus can be used continually, thereby reducing the cost of replacing the mold apparatus. The film transfer method does not require forming a concave-convex structure on the surface of the mold apparatus, which is energy-saving, timesaving and labor-saving, and can avoid environment pollution caused by strong acid or strong base and the damage to the staff caused thereby.

### BRIEF DESCRIPTION OF THE DRAWINGS

FIG. 1 illustrates a cross-sectional view of a mold apparatus used in a film transfer method according to an embodiment of the invention when the mold apparatus is not closed;

FIG. 2 illustrates a cross-sectional view of the mold apparatus shown in FIG. 1 when the mold apparatus is closed;

FIG. 3A illustrates a partially enlarged view of the film substrate shown in FIG. 2;

FIG. 3B illustrates another embodiment of he film substrate shown in FIG. 3A;

FIG. 4 illustrates a cross-sectional view of the mold apparatus shown in FIG. 2 when a melted plastic is injected;

FIG. 5A illustrates a cross-sectional view of the film substrate shown in FIG. 3A being covered by the melted plastic;

FIG. 5B illustrates a cross-sectional view of the film substrate shown in FIG. 3B being covered by the melted plastic;

FIG. 6 illustrates a cross-sectional view of the mold apparatus shown in FIG. 4 when the mold apparatus is demounted;

FIG. 7 illustrates a flow chart of the film transfer method according to an embodiment of the invention;

FIG. 8 illustrates a perspective view of an appearance member according to an embodiment of the invention;

FIG. 9 illustrates a cross-sectional view of the appearance member taken along line 9-9 shown in FIG. 8; and

FIG. 10 illustrates a cross-sectional view of the mold apparatus used in the film transfer method according to an embodiment of the invention when the mold apparatus is not closed.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

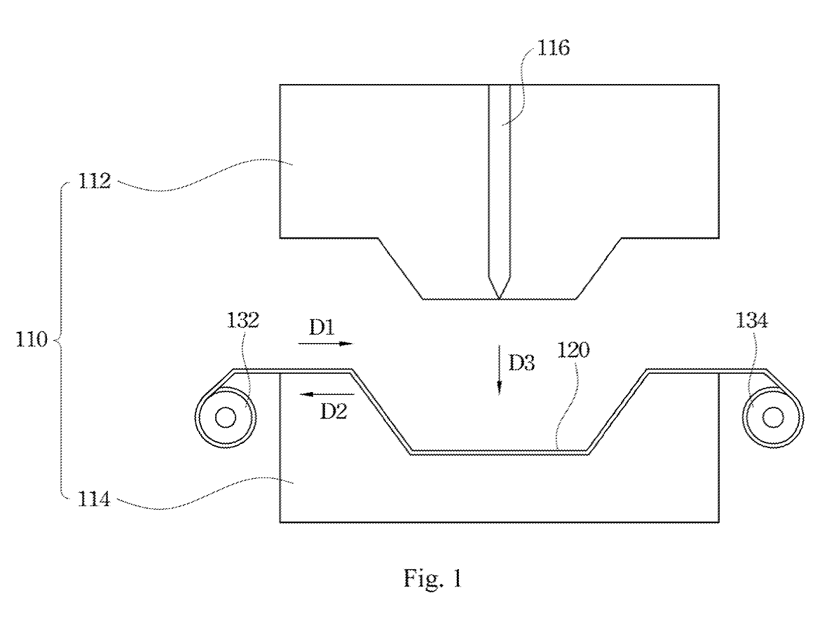

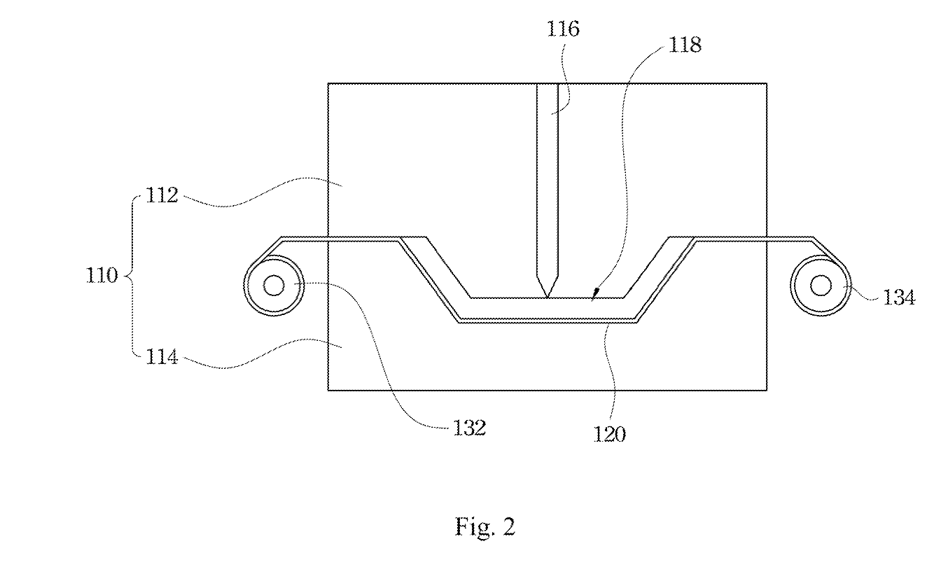

FIG. 1 illustrates a cross-sectional view of the mold apparatus 110 used in the film transfer method according to an embodiment of the invention when the mold apparatus is not closed. As shown in the figure, the mold apparatus 110 includes a male mold 112 and a female mold 114, and the male mold 112 is positioned above the female mold 114, capable of being raised and lowered. Two rollers 132, 134 are respectively positioned at two opposite sides of the mold apparatus 110, and two ends of the film substrate 120 are respectively connected to the two rollers 132, 134. When the two rollers 132, 134 are rotated towards the same direction, the film substrate 120 can move on the female mold 114 of the mold apparatus 110. For example, when the two rollers 132, 134 are rotated clockwise, the film substrate 120 moves towards a direction D1. When the two rollers 132, 134 are rotated counterclockwise, the film substrate 120 moves towards a direction D2. After the position of the film substrate 120 is adjusted, the mold apparatus 110 can be closed, making the male mold 112 move towards a direction D3 and be abutted against the female mold 114, as shown in FIG. 2. In the following description, “closing the mold” refers to making the male mold 112 be abutted against the female mold 114, and “demounting the mold” refers to making the male mold 112 be departed from the female mold 114 with a certain distance.

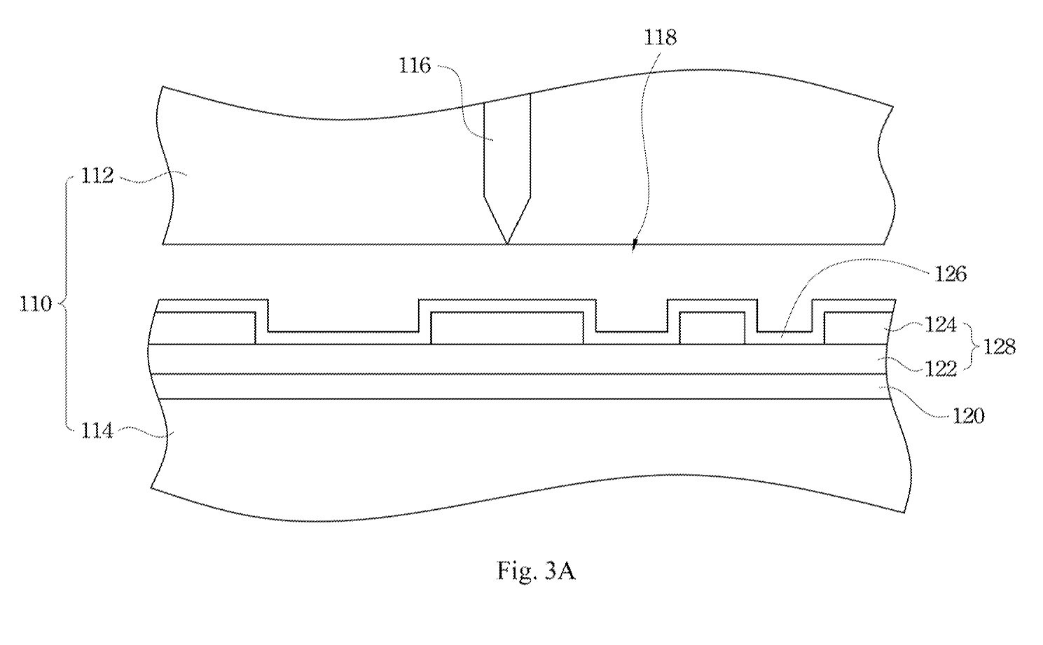

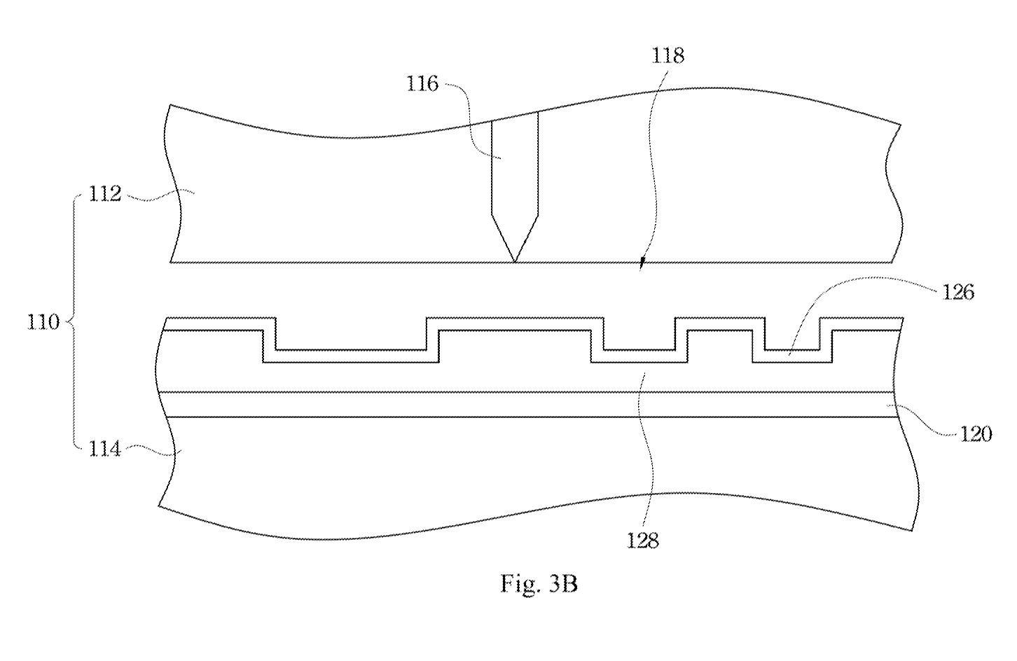

FIG. 2 illustrates a cross-sectional view of the mold apparatus 110 shown in FIG. 1 when the mold apparatus 110 is closed. FIG. 3A illustrates a partially enlarged view of the film substrate 120 shown in FIG. 2. As shown in FIG. 2 and FIG. 3A, when the male mold 112 and the female mold 114 of the mold apparatus 110 are closed, a mold cavity 118 exists between the male mold 112 and the female mold 114. The mold apparatus 110 clamps the film substrate 120 outside the mold cavity 118 to enable the film substrate 120 to be positioned in the mold cavity 118. Furthermore, the male mold 112 is provided with a material injection channel 116 for injecting the melted plastic (e.g., plastic cement) into the mold cavity 118.

In this embodiment, the material of the film substrate 120 may include polyethylene terephthalate (PET). The film substrate 120 has a three-dimensional texture layer 128 and a mold release layer 126. The three-dimensional texture layer 128 includes printing inks 122, 124, and the printing inks 122, 124 may include flatting silica, aluminium powder or pearl powder. Moreover, the printing inks 122, 124 may be two different layers of printing inks, which jointly form the three-dimensional texture layer 128 with varied surface properties (such as the brightness, roughness and depth) on the film substrate 120. The three-dimensional texture layer 128 can be formed through intaglio printing or screen painting, and the surface properties (such as the brightness and roughness) of the three-dimensional texture layer 128 can be defined by adjusting the ratio or particle diameter of the flatting silica, aluminium powder or pearl powder. Taking the intaglio printing as an example, a plurality of grooves may first be formed on the roller for intaglio printing, and the grooves may have different depths or widths. Subsequently, processing and adjustment of brightness and roughness can be performed on the surface of the grooves, for example using printing inks with different properties, and then an intaglio printing and oven-drying process is performed to a PET film to obtain the film substrate 120.

The mold release layer 126 can be used for separating the solidified plastic (such as the plastic cement) from the three-dimensional texture layer 128 of the film substrate 120. When the film substrate 120 having the three-dimensional texture layer 128 is formed, the mold release layer 126 can be coated on the three-dimensional texture layer 128 of the film substrate 120 and then oven-dried.

FIG. 3B illustrates another embodiment of the film substrate 120 shown in FIG. 3A. The difference between this embodiment and the embodiment shown in FIG. 3A is that: The three-dimensional texture layer 128 includes an ultraviolet-solidified gel, and the three-dimensional texture layer 128 can be formed through imprinting or nano imprinting lithography (NIL). Taking the imprinting as an example, an ultraviolet-solidified gel can be first coated on the PET film, and then oven-dried, and subsequently imprinting is performed under the non-solidified state of the ultraviolet-solidified gel. Imprinting refers to forming minute and diversified textures on a mold apparatus through various processing manners (such as nano laser, tooling, etching, printing, painting and adhering). That is, when such an external-light solidified gel is used, the line width or depth of the texture is controlled through an imprinting or nano imprinting lithography, rather than changing the brightness and roughness of the surface of the printing ink layer by adjusting the ratio or particle diameter of the flatting silica, aluminium powder or pearl powder through a printing manner.

Furthermore, by changing the line width or depth of the texture through imprinting, a structure like optical grating can be formed on the surface of the ultraviolet-solidified gel, such that an optical diffraction effect can be generated on the surface of the finally formed appearance member.

In FIG. 3A, the printing inks 122, 124 of two or more layers included in the three-dimensional texture layer 128 can jointly cause the variable properties of the surface. For example, the brightness and roughness of the surface of the layers of printing inks 122, 124 can be changed by adjusting the ratio or particle diameter of the flatting silica, aluminium powder or pearl powder. However, for the three-dimensional texture layer 128 shown in FIG. 3B, the printing inks 122, 124 shown in FIG. 3A are replaced by an ultraviolet-solidified gel. When the three-dimensional texture layer 128 uses the ultraviolet-solidified gel, the three-dimensional texture is mainly formed through an imprinting or nano imprinting lithography manner, but a more variable texture surface can be obtained through the printing manner with printing ink, by adding materials such as flatting silica, aluminium powder or pearl powder into the ultraviolet-solidified gel.

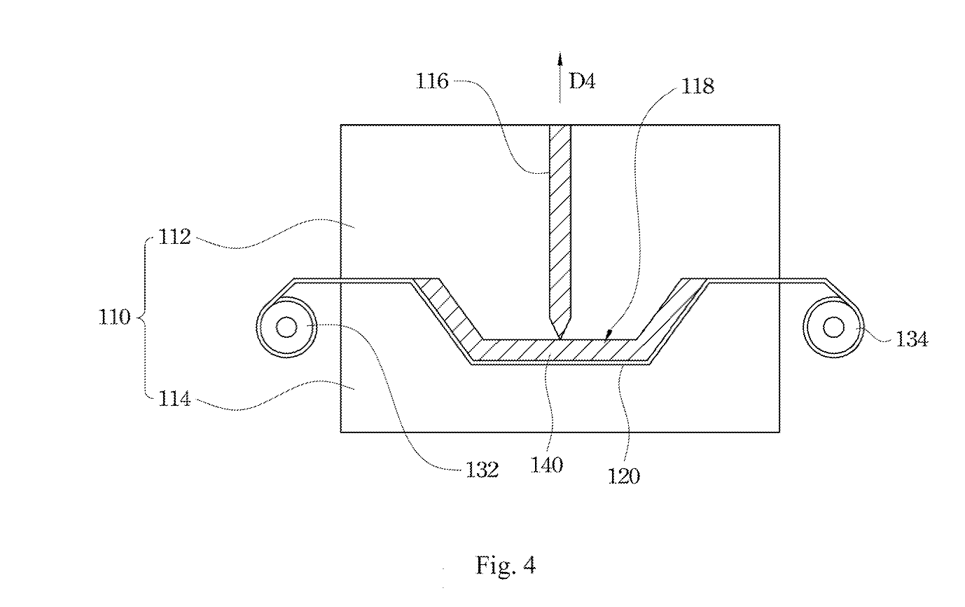

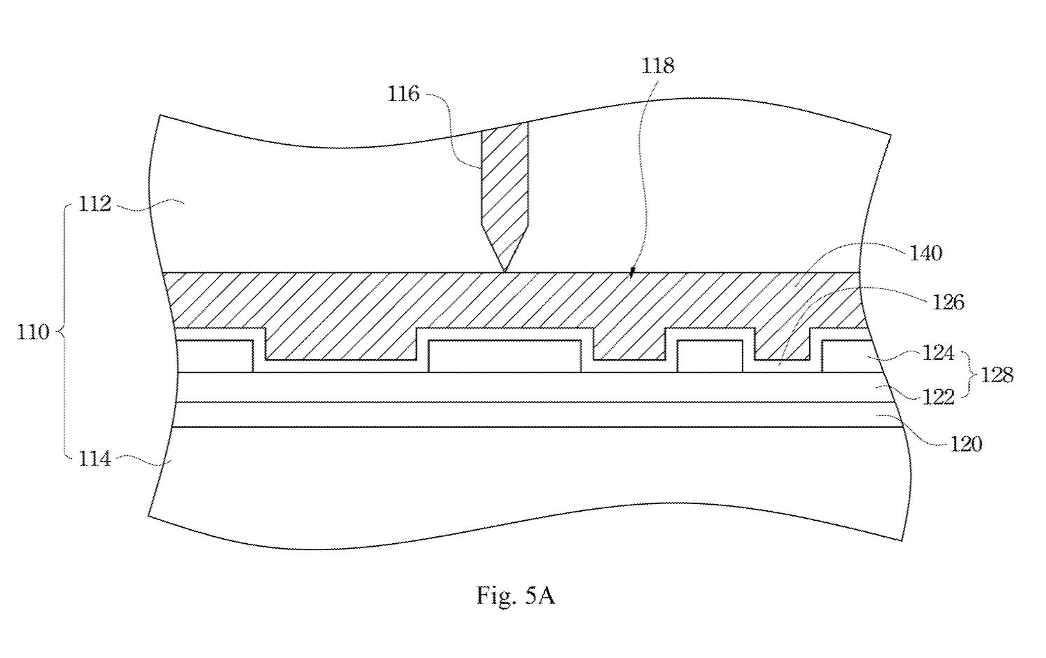

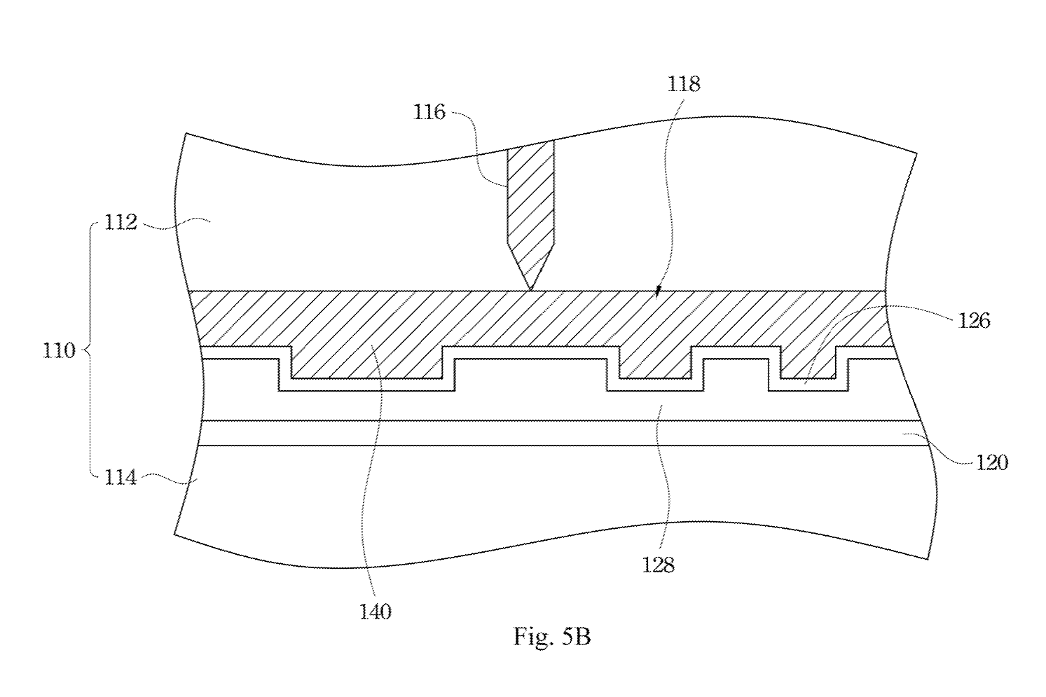

FIG. 4 illustrates a cross-sectional view of the mold apparatus 110 shown in FIG. 2 when a melted plastic 140 is injected. FIG. 5A illustrates a cross-sectional view of the film substrate 120 shown in FIG. 3A being covered by the melted plastic 140. As shown in FIG. 4 and FIG. 5A, the melted plastic 140 is injected into the mold cavity 118 through the material injection channel 116, such that the melted plastic 140 covers the three-dimensional texture layer 128 of the film substrate 120. As such, after the melted plastic 140 is solidified, a concave-convex structure can be formed on the surface of the solidified plastic 140 facing the three-dimensional texture layer 128, and at meanwhile the male mold 112 can be departed from the female mold 114 along a direction D4.

FIG. 5B illustrates a cross-sectional view of the film substrate 120 shown in FIG. 3B being covered by the melted plastic 140. The difference between FIG. 5A and FIG. 56 is only the difference of structures and materials of the three-dimensional texture layer 128 of the film substrate 120, which will not be illustrated anymore.

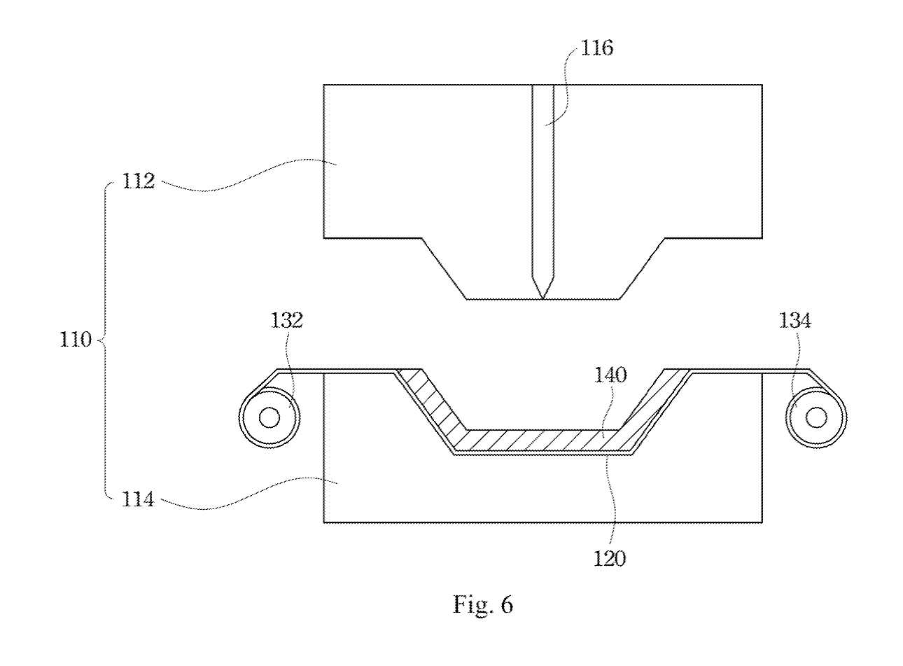

FIG. 6 illustrates a cross-sectional view of the mold apparatus 110 shown in FIG. 4 when the mold apparatus 110 is demounted. After the plastic 140 is solidified, the mold apparatus 110 can be demounted, and the solidified plastic 140 can be acquired from the mold apparatus 110. As shown in FIG. 5A, FIG. 5B, since the mold release layer 126 is positioned between the three-dimensional texture layer 128 and the plastic 140, the solidified plastic 140 can be easily separated from the three-dimensional texture layer 128 of the film substrate 120, without adhering to the printing inks 122, 124 or the ultraviolet-solidified gel. After the solidified plastic 140 is taken out, the film substrate 120 can perform the next film transfer process, or control the two rollers 132, 134 to move towards the same direction. Another film substrate 120 which has never been used for film transfer can be used according to the requirement of the user.

In sum, since the film substrate 120 having the three-dimensional texture layer 128 is positioned in the mold cavity 118 of the mold apparatus 110, when the melted plastic 140 is injected to the mold cavity 118, the melted plastic 140 covers the three-dimensional texture layer 128 of the film substrate 120. As such, when the melted plastic 140 is solidified, it only needs to separate the solidified plastic 140 from the three-dimensional texture layer 128 of the film substrate 120, and thus the surface of the solidified plastic 140 facing the three-dimensional texture layer 128 has the concave-convex structure. The aforesaid solidified plastic 140 may be an appearance member, and the pattern of the concave-convex structure is approximately the same as the three-dimensional texture layer 128 of the film substrate 120.

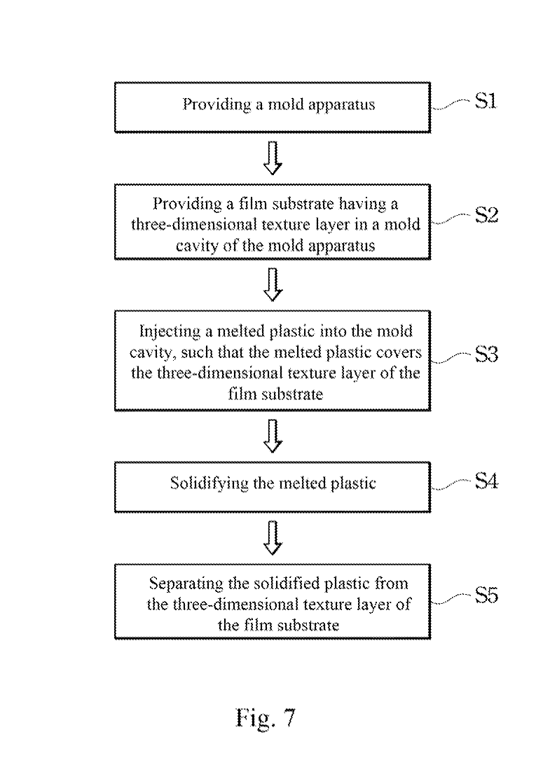

FIG. 7 illustrates a flow chart of the film transfer method according to an embodiment of the invention. First in step S1, a mold apparatus is provided. Then in step S2, a film substrate having a three-dimensional texture layer is provided in a mold cavity of the mold apparatus. Thereafter in step S3, a melted plastic is injected into the mold cavity, such that the melted plastic covers the three-dimensional texture layer of the film substrate. Subsequently in step S4, the melted plastic is solidified. Finally in step S5, the solidified plastic is separated from the three-dimensional texture layer of the film substrate.

Furthermore, the film transfer method may further include coating a mold release layer on the three-dimensional texture layer of the film substrate and oven-drying the mold release layer.

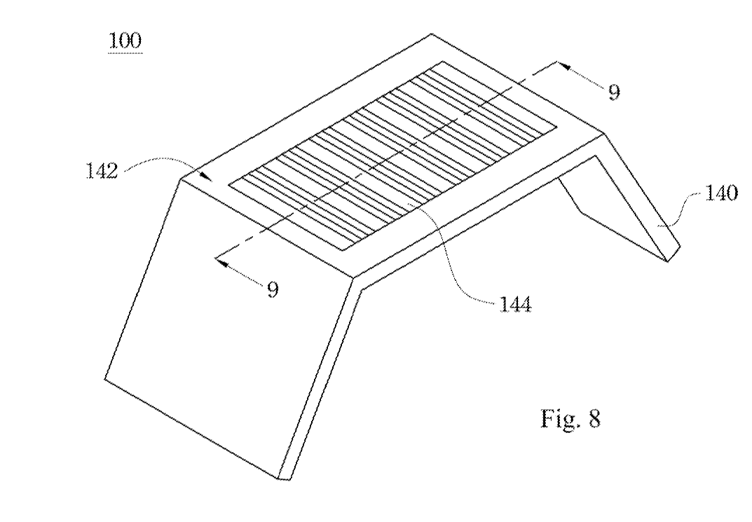

FIG. 8 illustrates a perspective view of an appearance member 100 according to an embodiment of the invention. The appearance member 100 is manufactured by using the aforesaid film transfer method. The appearance member 100 includes a surface 142 and the surface 142 has a concave-convex structure 144. The pattern of the concave-convex structure 144 is the same as the three-dimensional texture layer 128 of the film substrate 120 (referring to FIG. 5A and FIG. 5B).

When the appearance member 100 is manufactured by using the film substrate 120 shown in FIG. 5A, the concave-convex structure 144 may be a touch sensing structure with different roughness. When the roughness of the concave-convex structure 144 is small, a smooth feel is obtained when the hand touches the concave-convex structure 144, and a bright surface is formed under the irradiation of light. When the roughness of the concave-convex structure 144 is large, a rough feel is obtained when the hand touches the concave-convex structure 144, and a darker surface is formed under the irradiation of light. As such, the tactile sensation of the surface 142 of the appearance member 100 is improved.

Additionally, when the appearance member 100 is manufactured by using the film substrate 120 shown in FIG. 5B, the concave-convex structure 144 may be an optical diffraction structure which can generate an optical diffraction effect of the light irradiating the concave-convex structure 144. When the surface 142 of the appearance member 100 is viewed, the concave-convex structure 144 can cause a visual effect with variable shadows and colors, which improves the tactile sensation of the surface 142 of the appearance member 100.

As shown in FIG. 5A and FIG. 5B, the three-dimensional texture layer 128 of the invention is manufactured of a material through specific texture manufacture methods, which enables the appearance member 100 to have surfaces of different effects. When the three-dimensional texture layer 128 is the printing inks 122, 124 shown in FIG. 5A, the three-dimensional texture layer 128 is formed through printing, which enables the effect that the surface of the appearance member 100 has different brightness variations and tactile sensations. When the three-dimensional texture layer 128 is the ultraviolet-solidified gel shown in FIG. 5B, the three-dimensional texture layer 128 is formed through imprinting, enabling the surface of the appearance member 100 has an optical diffraction effect.

The film transfer method uses the film substrate 120 having the three-dimensional texture layer 128 to form the concave-convex structure 144 of the appearance member 100. When the concave-convex structure 144 of the appearance member 100 needs to be replaced by different decorative textures, it only needs to replace the film substrate 120 by a film substrate of another type (i.e., a film substrate 120 having a different three-dimensional texture layer 128), and the mold apparatus 110 can be used continually, thereby reducing the cost of replacing the mold apparatus 110.

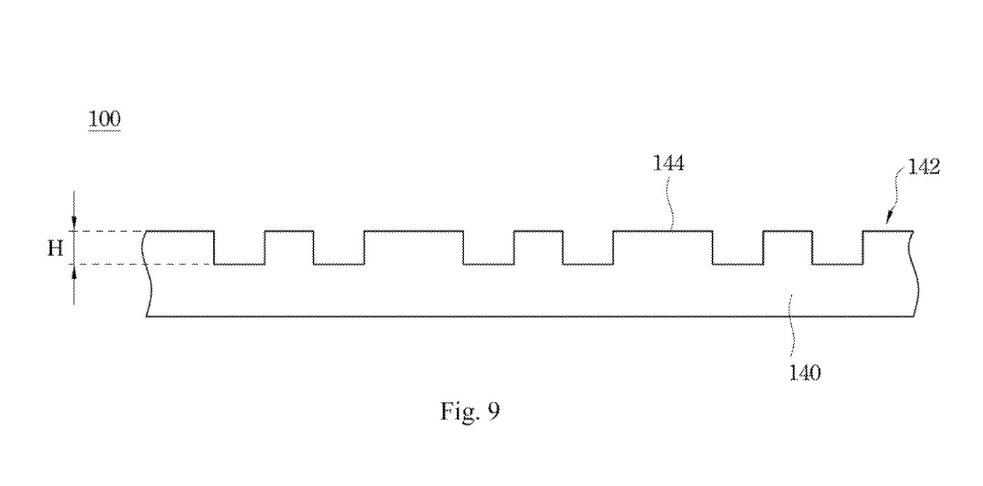

FIG. 9 illustrates a cross-sectional view of the appearance member 100 tacken along line 9-9 shown in FIG. 8. In this embodiment the height difference H in the concave-convex structure 144 is from 1 to 50 μm.

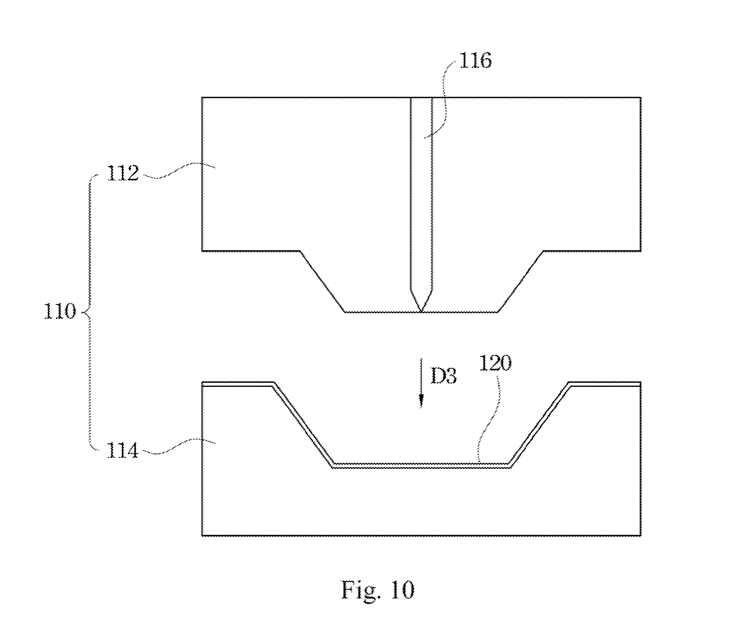

FIG. 10 illustrates a cross-sectional view of the mold apparatus 110 used in the film transfer method according to an embodiment of the invention when the mold apparatus is not closed. The mold apparatus 110 includes a male mold 112 and a female mold 114, and the male mold 112 is positioned above the female mold 114, capable of being raised and lowered. The difference of between this embodiment and the embodiment shown in FIG. 1 is that: The film substrate 120 is plate-shaped and directly placed on the female mold 114 of the mold apparatus 110, and is not connected to the rollers 132, 134 shown in FIG. 1. After the position of the film substrate 120 is adjusted, the mold apparatus 110 can be closed, making the male mold 112 move towards the direction D3 and be abutted against the female mold 114. Other production processes are similar to those shown in FIG. 2 to FIG. 6, and will not be described anymore.

As comparing the aforesaid embodiments of the invention with the prior art, this film transfer method uses the film substrate having the three-dimensional texture layer to form the concave-convex structure of the appearance member. When the concave-convex structure of the appearance member needs to be replaced by a different decorative texture, it only needs to replace the film substrate by a film substrate of another type, and the mold apparatus can be used continually, thereby reducing the cost of replacing the mold apparatus. The film transfer method does not require forming a concave-convex structure on the surface of the mold apparatus, which is energy-saving, timesaving and labor-saving, and can avoid environment pollution caused by strong acid or strong base and the damage to the staff caused thereby.

The reader's attention is directed to all papers and documents which are filed concurrently with this specification and which are open to public inspection with this specification, and the contents of all such papers and documents are incorporated herein by reference.

All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar feature

What is claimed is:

1. A film transfer method comprising:
(a) providing a mold apparatus;
(b) providing a film substrate having a three-dimensional texture layer in a mold cavity of the mold apparatus;
(c) injecting a melted plastic into the mold cavity, such that the melted plastic covers the three-dimensional texture layer of the film substrate;
(d) solidifying the melted plastic; and
(e) separating the solidified plastic from the three-dimensional texture layer of the film substrate.

2. The film transfer method as claimed in claim 1, further comprising:
coating a mold release layer on the three-dimensional texture layer of the film substrate; and
oven-drying the mold release layer.

3. The film transfer method as claimed in claim 2, wherein the mold release layer is used for separating the solidified plastic from the three-dimensional texture layer of the film substrate.

4. The film transfer method as claimed in claim 1, further comprising:
providing two rollers at two opposite sides of the mold apparatus, wherein two ends of the film substrate are respectively connected to the two rollers; and
rolling the two rollers, such that the film substrate moves on the mold apparatus.

5. The film transfer method as claimed in claim 1, further comprising:
closing the mold apparatus, such that the film substrate is positioned in the mold cavity of the mold apparatus.

6. The film transfer method as claimed in claim 1, further comprising:
demounting the mold apparatus and acquiring the solidified plastic from the mold apparatus.

7. The film transfer method as claimed in claim 1, wherein the film substrate is plate-shaped.

8. The film transfer method as claimed in claim 1, wherein the three-dimensional texture layer comprises a printing ink or ultraviolet-solidified gel.

9. The film transfer method as claimed in claim 1, wherein the three-dimensional texture layer comprises a flatting silica, aluminium powder or pearl powder.

10. The film transfer method as claimed in claim 1, wherein the material of the film substrate comprises polyethylene terephthalate (PET).

11. The film transfer method as claimed in claim 1, wherein the three-dimensional texture layer is formed through intaglio printing, screen painting, imprinting or nano imprinting lithography.

12. An appearance member manufactured by using the film transfer method of claim 1, wherein the appearance member comprises:
a surface having a concave-convex structure, wherein the pattern of the concave-convex structure is the same as the three-dimensional texture layer of the film substrate.

13. The appearance member as claimed in claim 12, wherein the concave-convex structure is an optical diffraction structure for diffracting a light which irradiates the concave-convex structure.

14. The appearance member as claimed in claim 12, wherein the concave-convex structure is a touch sensing structure with different roughness.

15. The appearance member as claimed in claim 12, wherein the height difference in the concave-convex structure is from 1 to 50 μm.
